(19) United States
(12) Patent Application Publication
(10) Pub. No.: US 2016/0068012 A1
(43) Pub. Date: Mar. 10, 2016

(54) VENETIAN MOSAIC MADE WITH POLYMERS

(71) Applicant: Gustavo Antonio MULLER, Provincia de Santa Fe (AR)

(72) Inventor: Gustavo Antonio MULLER, Provincia de Santa Fe (AR)

(21) Appl. No.: 14/847,040

(22) Filed: Sep. 8, 2015

(30) Foreign Application Priority Data
Sep. 8, 2014 (AR) 20140103334

(51) Int. Cl. B44C 3/12

(52) U.S. Cl. CPC B44C 3/123

(57) ABSTRACT

Polymers based venetian mosaic made of a plurality number of tiles, linked to each other through a clamping bridge that connects every tile to the next one, in a way that creates a rigid and supportive structural unit among every single piece. The mosaic's manufacture includes the injection of different types of polymers through an injection machine in a specific matrix, that will allow obtaining in only one step, the complete mosaic with its corresponding tiles connected to each other. The mosaic size, shape and texture will depend exclusively on the matrix used at the moment of the injection of the polymer.

### TECHNICAL FIELD

The following invention relates to the manufacturing of Venetian mosaic made with polymers, the being understood to be a unit made of indefinite number of small tiles made with, in this case, polymers, linked to each other through a clamping bridge also made of such material. Its main purpose in construction is to be used as decorative coating.

It is a unit made of an indefinite number of small tiles connected by a clamping bridge, constituting a venetian mosaic tile which dimensions can vary according to the design, and which adheres to the holder to coat through the use of a mixed cement based adhesive that is available on the market.

### DESCRIPTION OF PRIOR ART AND PROBLEMS TO SOLVE

Comparing this new product with the existing venetians mosaics tile that are available on the market, such as glass, stone, wood, etc., the innumerable differences and advantages this new product presents are highlighted. For example, the achievement of a greater precision regarding the measure of every tile and on the separation between each one of them when forming the mosaic tile, even a greater precision on the shades which they will be colored with and also, the detachment prevention of individual tiles thanks to the clamping bridge that connects them to each other.

Since the venetian mosaic first appeared, more than 2000 years ago, its production process has remain untouched over time, despite the advances in the manufacturing processes which consisted on the individual manufacture of every tile that later will be connected for its collocation, either through a plaster layer, gummed paper, glass fibre mesh, etc. This makes its manufacturing slow and imprecise, when it comes to the division among every tile, the shades with which they are colored, etc. With this new product not only those inaccuracies would be solved, but also a complete mosaic made of tile connected through a clamping bridge will be achieved in one step; all manufactured with the same material.

The storage, transportation and placement on construction site become considerably easier due to the fact that, against the already known mosaic, it is approximately a 60% lighter. The weight of the already known venetian mosaic is 7 and 8 kilograms per square meter, while the new polymers based venetian mosaic weight is 2 or 3 kilograms per square meter. It requires less of a physical area for its storage, and less transportation's logistics, which means less pollution.

As regards its collocation, not only it becomes easier because of its their lighter weight but also because of its clamping bridges system, that connects the different tiles, at the moment of the collocation in vertical surface, sliding is prevented.

Another advantage is that the result can be seen at the moment of the collocation and corrections can be made if necessary. This is not possible with the products known nowadays since they are covered with a paper layer, used to connect the tiles, and which can only be removed a few hours after the material used to adhere the mosaic to the support hardens.

At present time, the production of mosaics is carried out through different processes, such as the collection of raw materials (sand, sand quartz, oxides, etc.), which must be molten in a furnace at high temperature for a few hours to shape the tile through a mould which then should be cooled. Once obtained the tile, they will be collected in a bulk (this cause some waste due to the fact that many of them break) for a while, to then initiate the stage of the mosaic assembling through the join connection of every tile to a gummed paper of glass fiber mesh. All this requires big physical areas, which will be reduced to a 70% thanks to the injection process necessary in the manufacturing of the proposed product, so as the reduction of the amount of gas used, which means less of a environmental impact and a reduction of expenses and time.

In summary, the advantages of the proposed product against the already known product are:
1. Less specific weight in the finished product against any other known product.
2. Less environmental impact on its manufacturing due to the raw material used, that could be even be made of recycled plastic.
3. Storage. As being an unalterable product and not containing paper for the tiles connection, it is not affected by weather conditions.
4. Higher precision on the individual tiles size and on the space between them.
5. Greater facility in the coating collocation labor. Since it is a (structurally solid unit) unit structurally joint among the parts, individual movements and subsidence of the mosaics are prevented.
6. Its manufacturing process requires less infrastructure and time.
7. The gummed paper, resin or glass fiber mesh, that have its own way of manufacturing, are replaced by the new way of union of the pieces for the assembling, which is solved in only one production process.

### SUMMARY OF THE INVENTION

For the specified purposes, this invention relates to the manufacturing of venetian mosaic based on polymers, understanding this to be a unit made of an indefinite number of small tiles in this case, made with polymers, linked to each other through a clamping bridge also made of such material. This invention is achieved through the injection of different types of polymers on a specific matrix.

Such venetian mosaics are obtained in only one step and constructed in a faster, simpler, and more economical way.

### BRIEF DESCRIPTION OF THE DRAWINGS

To make the subject matter of the invention more intelligible, it has been drawn on three schematic figures, which are taken as demonstratives examples. It can be observed:

FIG. 1 is a frontal view of a venetian mosaic, made of 169 tiles, square in this case, connected by a polymers based clamping bridge. Also, the separating space can be seen.

FIG. 2 is a lateral view of a venetian mosaic, made of an indefinite number of tiles connected to each other through a clamping bridge. Furthermore, it can be seen that this bridge is made in low relief in the seen face of the mosaic, which allows the correct attachment of the joints and it favors the full clamping of the mosaic, avoiding individual detachment of a tile.

FIG. 3 is a detailed view of the A section of FIG. 2. It can be seen a lateral view of a tile with its corresponding clamping bridge, which connects it to the next one, so as the back cavity that will be filled with the cement based adhesive, improving its adherence to the support.

### DETAILED DESCRIPTION OF THE INVENTION

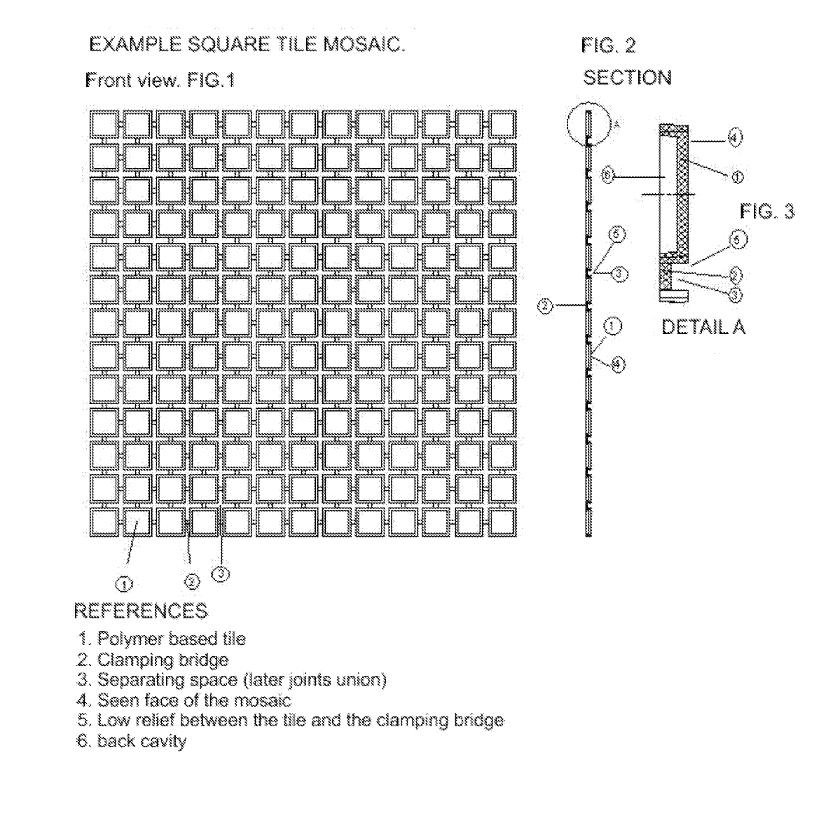

This invention comprises the manufacturing of venetian mosaic based on polymers, made of an indefinite number of tiles linked each other through a clamping bridge also made of polymers. Apart from joining the pieces, the bridge maintains a space between them, as can be seen on FIG. 1, and this space allows adjustments in the coating, so as its later joints union with the pastine or cement.

Each tile can be filled up, thanks to its back cavity design, with cement based adhesive, improving its adherence to the support, as can be seen on FIG. 3. The clamping bridge designed in low relief in reference to the seen face of the mosaic, as can be seen on FIGS. 2 and 3, facilitates the anchoring of the complete mosaic and also avoids the individual detachment of a tile, as it usually happens.

Regarding its manufacturing, different types of mosaics can be obtained, for example opaque, translucent, or of various colors, which will be retained an even tone, due to the facility that the polymers can be colored with. This is very difficult with tiles made of materials currently used, as for example glass.

The mosaic's size, shape and texture, will depend only on the matrix used at the moment of the injection of the polymer, taking as example for the illustrations, square mosaics.

The tiles and the clamping bridge are made of the at least one polymer selected from the group consisting of polyethylene and polymethylmethacrylate ethylene.

Having described and determined the nature and reach of the invention and the way to put it into practice, the embodiments of the invention in which an exclusive property or privilege is claimed are:

1. (canceled)

2. (canceled)

3. (canceled)

4. A venetian mosaic made of at least one polymer injected into a matrix.

5. The venetian mosaic according to claim 4, wherein the mosaic includes a plurality of tiles linked among each other, each tile is made of the at least one polymer.

6. The venetian mosaics according to claim 5, further including a clamping bridge to link adjacent tiles to each other.

7. The venetian mosaics according to claim 6, wherein the clamping bridge creates a space between adjacent tiles.

8. A venetian mosaic comprising:
a plurality of tiles made of at least one polymer injected into a matrix; and
a clamping bridge to link adjacent tiles to each other, the clamping bridge is made of the at least one polymer.

9. The venetian mosaics according to claim 4, wherein the at least one polymer includes a coloring agent.

10. A venetian mosaic comprising:
a plurality of tiles;
a clamping bridge to link adjacent the tiles to each other;
each tile and the clamping bridge are made of the at least one polymer selected from the group consisting of polyethylene and polymethylmethacrylate ethylene.
